(19) United States
(12) Patent Application Publication
(10) Pub. No.: US 2026/0366726 A1
(43) Pub. Date: Nov. 19, 2026

(54) SYSTEMS AND METHODS FOR BATTERY-ASSISTED COOKING IN A COOKING APPLIANCE

(71) Applicant: Haier US Appliance Solutions, Inc., Wilmington, DE (US)

(72) Inventor: Eric Scott Johnson, Louisville, KY (US)

(21) Appl. No.: 19/209,933

(22) Filed: May 16, 2025

(51) Int. Cl. F24C 7/08; H02J 7/90; H02J 9/06

(52) U.S. Cl. CPC F24C 7/087; H02J 7/975; H02J 9/068

(57) ABSTRACT

A method of operating a cooking appliance, the cooking appliance including one or more electric heaters, a main power connection to a main supply of electrical power, an auxiliary power connection to a battery supply of electrical power, and a power switching system configured to selectively couple at least one of the main power connection or the auxiliary power connection to the one or more electric heaters. The method includes obtaining an ambient parameter of an environment where the battery supply is located, establishing a maximum battery power threshold based at least in part on the ambient parameter of the environment, and operating the power switching system to energize the one or more electric heaters to limit the electrical power provided from the battery supply to the maximum battery power threshold.

### FIELD OF THE INVENTION

The present subject matter relates generally to oven appliances, and more particularly, to systems and methods of battery-assisted cooking in a cooking appliance.

### BACKGROUND OF THE INVENTION

Conventional residential and commercial cooking appliances generally include a cabinet that includes a cooking chamber (e.g., an oven chamber) for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. In addition, cooking appliances commonly include a cooktop positioned on top of the oven chamber and having a plurality of gas burners or electric heating elements for heating pots, pans, etc. These cooking appliances are often called “oven range appliances,” “oven ranges,” or simply “ranges.”

Notably, conventional cooking appliances that include electric heating elements in the oven chamber and electric heating elements on the cooktop that are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric oven ranges may be disappointed when their product cannot be used when installed or when they need to hire an electrician to rewire prior to operation. In addition, conventional cooking appliances are operated entirely from mains electricity, thus providing no ability to reduce peak loads on the electrical grid, shift energy use to off-peak times, etc. In addition, batteries with sufficient energy to power a cooking appliance generate significant internal heat, which can result in battery failure, shorter battery lifetime, tripping of thermal cut-off switches, and other operability issues.

Accordingly, an electric cooking appliance that may operate using an energy source other than mains electricity would be desirable. More specifically, a cooking appliance that is versatile and operates to prevent the battery from exceeding its rated temperature, thus prolonging battery life would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooking appliance is provided, including one or more electric heaters, a main power connection to a main supply of electrical power, an auxiliary power connection to a battery supply of electrical power, a power switching system configured to selectively couple at least one of the main power connection or the auxiliary power connection to the one or more electric heaters, and a controller in operative communication with the power switching system. The controller is configured to obtain an ambient parameter of an environment where the battery supply is located, establish a maximum battery power threshold based at least in part on the ambient parameter of the environment, and operate the power switching system to energize the one or more electric heaters to limit the electrical power provided from the battery supply to the maximum battery power threshold.

In another exemplary embodiment, a method of operating a cooking appliance is provided. The cooking appliance includes one or more electric heaters, a main power connection to a main supply of electrical power, an auxiliary power connection to a battery supply of electrical power, and a power switching system configured to selectively couple at least one of the main power connection or the auxiliary power connection to the one or more electric heaters. The method includes obtaining an ambient parameter of an environment where the battery supply is located, establishing a maximum battery power threshold based at least in part on the ambient parameter of the environment, and operating the power switching system to energize the one or more electric heaters to limit the electrical power provided from the battery supply to the maximum battery power threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to an example embodiment of the present subject matter.

FIG. 2 provides a front perspective view of the example cooking appliance of FIG. 1 with a door in the open position according to an example embodiment of the present subject matter.

FIG. 3 provides a side, schematic view of the example cooking appliance of FIG. 1 according to an example embodiment of the present subject matter.

FIG. 4 provides a side, schematic view of a heating system of the example cooking appliance of FIG. 1 according to an example embodiment of the present subject matter.

FIG. 5 provides a side, schematic view of a heating system of the example cooking appliance of FIG. 1 according to another example embodiment of the present subject matter.

FIG. 6 provides an electrical schematic view of a heating system and power switching system of the example cooking appliance of FIG. 1 according to an example embodiment of the present subject matter.

FIG. 7 provides a method of operating a cooking appliance according to an exemplary embodiment of the present subject matter.

FIG. 8 provides a plot illustrating the relationship between an ambient temperature and a maximum battery power threshold according to an example embodiment of the present subject matter.

FIG. 9 provides a plot illustrating the relationship between an ambient pressure and a maximum battery power threshold according to an example embodiment of the present subject matter.

FIG. 10 provides a flow chart illustrating the implementation of a battery-assisted cooking process of a cooking appliance according to an example embodiment of the present subject matter.

FIG. 11 provides a flow chart illustrating the implementation of a battery-assisted cooking process of a cooking appliance according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a method to limit the maximum power output of a battery in a cooking appliance, ensuring that the battery stays below its rated maximum temperature and prolonging battery life. This may be achieved by adjusting the maximum battery power output based on ambient conditions such as temperature and air pressure. A battery that powers a cooking appliance generates heat within its cells due to several processes (e.g., resistive heat, entropic heat, etc.). Battery self-heating may be a function of power (or current) draw and other factors. For example, a battery with an internal resistance of 0.36 ohms may generate 81 W of internal heat when providing a current of 15 A, and 144 W at 20 A. Battery heat may be dissipated by convection to surrounding air, e.g., through natural convection (buoyancy-driven flow) or forced convection (via a cooling fan). Ambient air conditions such as temperature and pressure influence the efficiency of convective heat dissipation. By reducing the maximum battery power output, when necessary due to unfavorable ambient conditions, the appliance prevents battery overheating, which is desirable for maintaining battery life and performance. The method may include adjusting a maximum battery power threshold based on predefined ambient conditions (e.g. ambient temperature and/or pressure). Alternatively, the method may include setting different maximum battery power thresholds for different ambient temperature or pressure ranges, or it may include continuously adjusting (or stepwise adjusting) the maximum battery power threshold based on real-time ambient conditions.

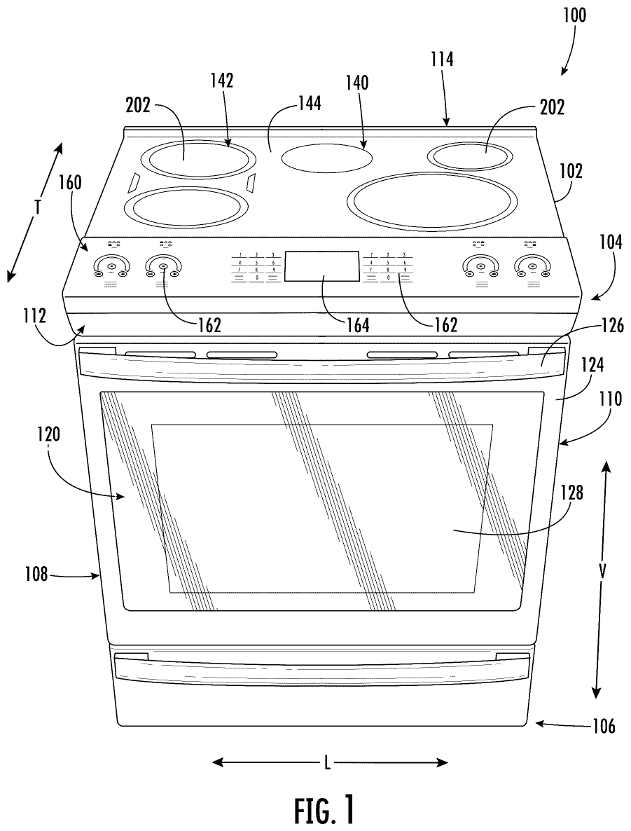

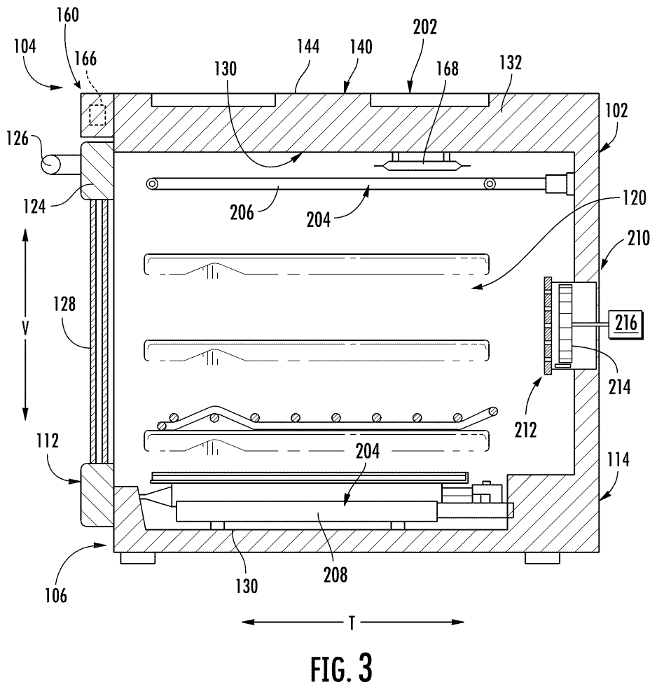

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooking appliance.

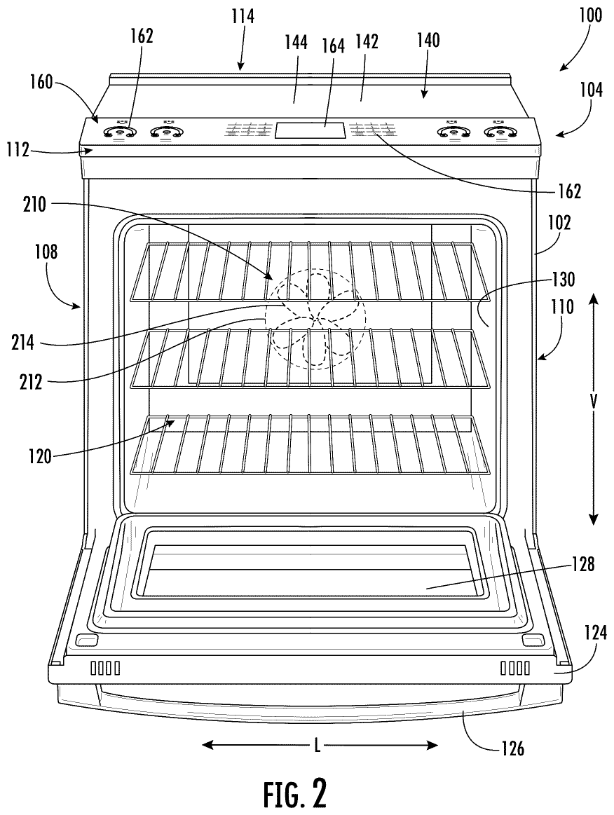

Referring now also to FIGS. 2 and 3, cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is at least partially filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Although aspects of the present subject matter are described herein in the context of a single cooking appliance, it should be appreciated that cooking appliance 100 is provided by way of example only. Other oven, cooktop, or range appliances having different configurations, different appearances, and/or different features may also be utilized with the present subject matter, e.g., double ovens, standalone cooktops, etc.

As illustrated, cooking appliance 100 may generally include a user interface panel 160 that is located within convenient reach of a user of the cooking appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one or more heating elements of cooking appliance 100. In this manner, control inputs 162 allow the user to activate each heating element and determine the amount of heat input provided by each heating element to a cooking food items within cooking chamber 120 or on cooktop 140. Although control inputs 162 are illustrated as touch-sensitive or contact inputs, it should be understood that control inputs 162 and the configuration of cooking appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element is activated and/or the rate at which the heating element is set.

User interface panel 160 may be in direct operative communication with a controller 166 of cooking appliance 100, such that user inputs via user interface panel 160 may be directly used to regulate operation of various components of cooking appliance 100. User interface panel 160 of cooking appliance 100 may be in communication with controller 166 via, for example, one or more signal lines or shared communication busses, and signals generated in controller 166 operate cooking appliance 100 in response to user input via user input devices 162. Input/Output (“I/O”) signals may be routed between controller 166 and various operational components of cooking appliance 100 such that operation of cooking appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be communication with one or more sensors, such as temperature sensor 168 (FIG. 3), which may be used to measure temperature inside cooking chamber 120 and provide such measurements to the controller 166. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that cooking appliance 100 may include any other suitable number, type, and position of temperature and/or other sensors according to alternative embodiments.

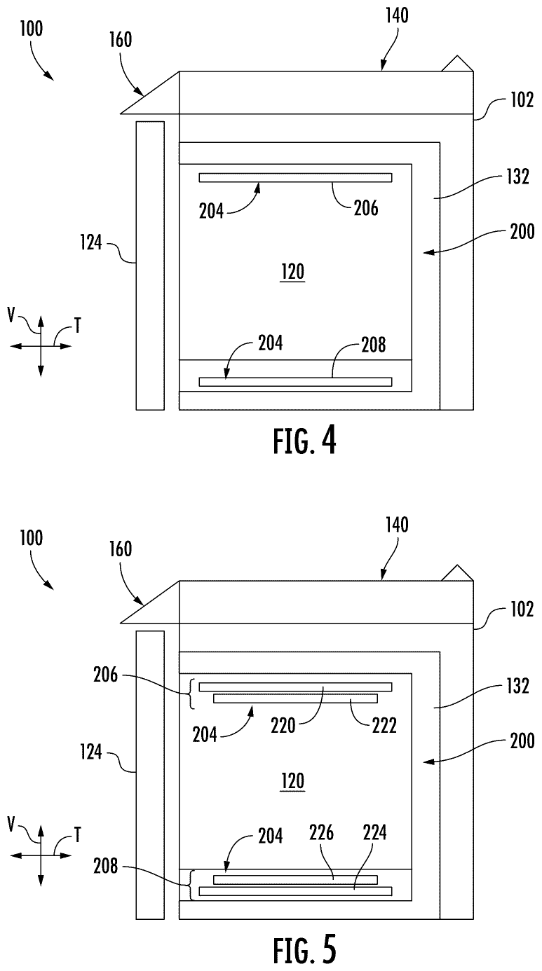

Referring now generally to FIGS. 1 through 5, a heating system 200 of cooking appliance 100 will be described according to an example embodiment of the present subject matter. Cooking appliance 100 may further include one or more heating elements or cooktop heaters (identified generally by reference numeral 202) for selectively heating cooking utensils positioned on glass panel 144. For example, referring to FIG. 1, cooktop heaters 202 may be electric heating elements or induction heating elements. Specifically, a plurality of cooktop heaters 202 are mounted within or on top of top panel 142 underneath a glass panel 144 that supports cooking utensils over the cooktop heaters 202 while cooktop heaters 202 provide thermal energy to cooking utensils positioned thereon, e.g., to heat food and/or cooking liquids (e.g., oil, water, etc.).

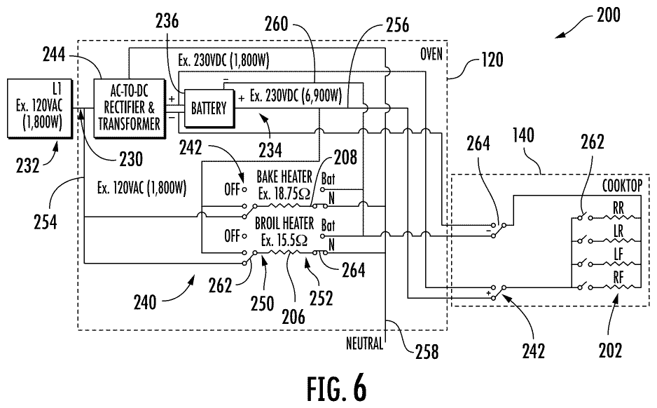

Cooktop heaters 202 can be configured in various sizes so as to provide e.g., for the receipt of cooking utensils (i.e., pots, pans, etc.) of various sizes and configurations and to provide different heat inputs for such cooking utensils. For example, as shown in FIG. 1, cooktop 140 includes five cooktop heaters 202 of different sizes, each of which may be independently controlled to facilitate operation of cooktop 140. By contrast, as shown in the schematic representation of FIG. 6, cooktop 140 may include four cooktop heaters 202, e.g., a rear right heater (RR), a left rear heater (LR), a left front heater (LF), and a right front heater (RF). According to alternative embodiments, cooking appliance 100 may have other cooktop configurations or burner elements.

In addition, cooking appliance 100 may include one or more chamber heaters 204 that may be positioned within or may otherwise be in thermal communication with cooking chamber 120 for regulating the temperature within cooking chamber 120. Specifically, an upper chamber heater, also referred to as a broil heating element 206, may be positioned in cabinet 102, e.g., at a top portion of cooking chamber 120, and a lower chamber heater, also referred to as a bake heating element 208, may be positioned at a bottom portion of cooking chamber 120. Broil heating element 206 and bake heating element 208 may be used independently or simultaneously to heat cooking chamber 120, perform a baking or broil operation, perform a cleaning cycle, etc. The size and heat output of heating elements 206, 208 can be selected based on the, e.g., the size of cooking appliance 100 or the desired heat output. According to example embodiments, broil heating element 206 and bake heating element 208 are electric heating elements. Cooking appliance 100 may include any other suitable number, type, and configuration of heating elements 202 within cabinet 102 and/or on cooktop 140.

In some embodiments, cooking appliance 100 includes a convection heating assembly 210 that operates in conjunction with chamber heaters 204 (e.g., broil heating element 206 and bake heating element 208) to facilitate convection cooking within cooking chamber 120. In this regard, convection heating assembly 210 may operate to circulate a flow of heated air within cooking chamber 120 to facilitate more even heating and shorter cooking cycle times. Although an example convection heating assembly 210 is described below, it should be appreciated that variations and modifications may be made while remaining within the scope of the present subject matter.

As best shown in FIG. 3, convection heating assembly 210 includes a convection fan enclosure 212 positioned proximate a rear of cooking chamber 120. In this regard, convection fan enclosure 212 is defined at least partially by a front wall and a rear wall spaced apart along the transverse direction T. The front wall may define one or more apertures that permit the flow of heated air to pass into and out of convection fan enclosure 212. According to alternative example embodiments, convection fan enclosure 212 may include alternative airflow paths, ducts, or other flow regulating devices for directing the flow of heated air within convection fan enclosure 212 and throughout cooking chamber 120.

As illustrated, convection heating assembly 210 further includes a convection fan 214 mounted in cabinet 102 (e.g., within convection fan enclosure 212) for circulating the flow of heated air in cooking chamber 120. Specifically, convection fan 214 is illustrated as a centrifugal fan, though other suitable fan types and configurations are possible and within the scope of the present subject matter. A drive motor 216 may be mounted to cabinet 102 and may be mechanically coupled to convection fan 214 for selectively rotating convection fan 214. Controller 166 may be in operative communication with drive motor 216 for selectively rotating convection fan 214 at desired times within a cooking cycle.

Referring now specifically to FIG. 5, each chamber heater 204 may include one or more heating stages that may be powered collectively or independently depending on the heating needs of cooking chamber 120 or the power available to cooking appliance 100. For example, as illustrated, broil heating element 206 may include a first heating stage 220 and a second heating stage 222. Similarly, bake heating element 208 may include a first heating stage 224 and a second heating stage 226. In general, the term “heating stages” may refer to subsets of chamber heaters 204 that are positioned adjacent to each other on the same face of the oven chamber or are embodied as a single heating element but which may be independently operated. According to example embodiments, these heating stages may each include different resistances, thereby facilitating versatility in the heating power applied through chamber heaters 204. Other variations and modifications to chamber heaters 204 and their respective heating stages are possible and within the scope of the present subject matter.

Referring now also to FIG. 6, an electrical schematic view of heating system 200 will be described according to an example embodiment of the present subject matter. As shown, heating system 200 may include a main power connection 230 to a main supply 232 of electrical power and an auxiliary power connection 234 to a battery supply 236. In this regard, cooking appliance 100 may be an electric oven that facilitates battery-assisted cooking. According to an example embodiment, main supply 232 may provide power at a first voltage (e.g., 120 VAC) and battery supply 236 may provide power at a second voltage (e.g., 230 VDC). It should be appreciated that these supply voltages may vary, and additional or alternative power sources may be incorporated into heating system 200 while remaining within the scope of the present subject matter.

According to example embodiments, main supply 232 may be mains electricity, e.g., provided by a utility provider to a conventional 120 VAC outlet within a user's residence. Battery supply 236 may be a battery supply or battery bank stored within cabinet 102 of cooking appliance 100 or may be a home battery supply electrically coupled or wired to cooking appliance 100. According to example embodiments, controller 166 may have a communication link with battery supply 236 (e.g., a remote connection with the home battery supply) for receiving operating parameters of battery supply 236, e.g., such as operating voltage, a maximum battery supply power draw, or other useful information.

As noted above, conventional cooking appliances that include electric heating elements in the oven chamber and electric heating elements on the cooktop are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric cooking appliances may be disappointed when their product cannot be used when installed or may need to hire an electrician to rewire prior to operation, resulting in user dissatisfaction. Heating system 200 may solve this problem by facilitating operation at a higher voltage, e.g., via use of power electronics and a higher voltage battery supply 236. Aspects of the present subject matter are directed to heating system 200 and power control systems and methods for facilitating such battery-assisted operation of cooking appliance 100.

In this regard, referring still to FIG. 6, heating system 200 may include a power switching system 240 configured to selectively couple main supply 232 and battery supply 236 to various heating elements of heating system 200. In this regard, power switching system 240 may include one or more switches 242, power electronics, power busses, and other electricity regulating devices for controlling the flow of power throughout heating system 200. In this regard, switches 242 may include single pole double throw relays, double pole double throw relays, contactors, transistors, or any other suitable devices for toggling, switching, or regulating the flow of electricity.

Power switching system 240 may also include a power electronics system 244 for converting alternating current (AC) power to direct current (DC) power or for converting DC power to AC power. For example, power electronics system 244 may include one or more inverters, rectifiers, voltage transformers, or other power electronics devices for converting power from AC to DC power (and vice versa), for adjusting voltage output, or for otherwise regulating or manipulating the flow of electricity as needed based on the call for heat from heating system 200.

According to the illustrated example embodiments, each heating element in heating system 200 (e.g., cooktop heaters 202 and chamber heaters 204) may include a high-voltage side 250 and a low-voltage side 252. Power switching system 240 may operate to selectively couple high-voltage sides 250 with a line connection 254 of main supply 232 or a positive terminal 256 of battery supply 236, e.g., based on a command from controller 166. Similarly, power switching system 240 may operate to selectively couple low-voltage sides 252 with a neutral line 258 of main supply 232 or a negative terminal 260 of battery supply 236, e.g., based on a command from controller 166.

As explained above, power switching system 240 includes one or more switches 242 to route power within power switching system 140 and heating system 200. For example, as illustrated in FIG. 6, switches 242 may include a high-side switch 262 for selectively coupling high-voltage side 250 of a particular heating element to line connection 254 of main supply 232 or positive terminal 256 of battery supply 236. In addition, switches 242 may include a low-side switch 264 for selectively coupling low-voltage side 252 to neutral line 258 of main supply 232 or negative terminal 260 of battery supply 236. As illustrated, high-side switches 262 and low-side switches 264 may be used to selectively route power to one or more cooktop heaters 202 and/or one or more chamber heaters 204.

According to another example embodiment, instead of having a high-side switch 262 and a low side switch 264 for each heating element, a first stage 220 of a first chamber heater, e.g., such as broil heating element 206, may be hard-wired to negative terminal 260 of battery supply 236, and a second stage 222 of the first chamber heater may be hard-wired to neutral line 258 of main supply 232. According to such an embodiment, power switching system 240 may include a battery supply switch for selectively coupling the first stage 220 of the first heating element (e.g., broil heating element 206) to battery supply 236 and a line supply switch for selectively coupling the second stage 220 of the first heating element to main supply 232.

As will be explained in more detail below, controller 166 may be in operative communication with power switching system 240 to regulate power flow based at least in part on the call for heat received from the temperature sensor and controller for regulating the operation of each respective heating element (e.g., cooktop heaters 202 and/or chamber heaters 204). In this regard, controller 166 may be configured to receive a call for heat associated with operation of the heating element (e.g., based on a user input via control inputs 162, a change in system state, etc.), determine a power schedule utilizing at least one of main supply 232 or battery supply 236, and operate power switching system 240 to deliver power to the heating element from at least one of 232 main supply or battery supply 236 in accordance with the power schedule. In cases where a chamber heater 204 includes two stages, the power schedule may include powering first stage 220/224 using only battery supply 236 and powering second stage 222/226 using only main supply 232.

Now that the construction of cooking appliance 100 and the configuration of an example heating system according to exemplary embodiments have been presented, an exemplary method 300 of operating a cooking appliance including a battery supply will be described. Specifically, method 300 may be used to perform a battery-assisted cooking process of cooking appliance 100. Although the discussion below refers to the exemplary method 300 of operating cooking appliance 100, one skilled in the art will appreciate that the exemplary method 300 is applicable to the operation of a variety of other cooking appliances, such as oven range appliances, cooktops, etc. In exemplary embodiments, the various method steps as disclosed herein may be performed by controller 166 or a separate, dedicated controller.

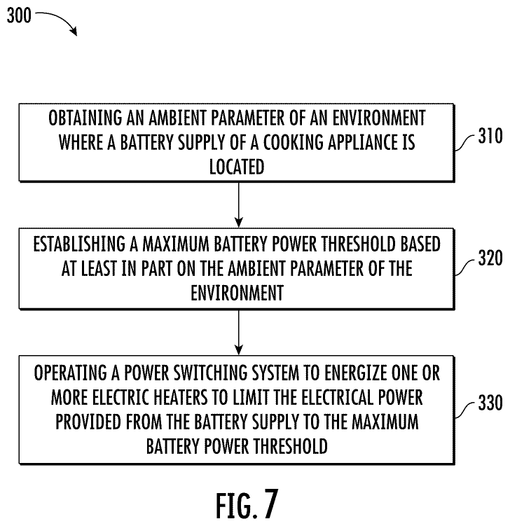

Specifically, referring now specifically to FIG. 7, method 300 includes, at step 310, obtaining an ambient parameter of an environment where the battery supply is located. In this regard, continuing the example from above, cooking appliance 100 may include a means of assessing and/or communicating the ambient parameter near the battery supply 206 to controller 166. As used herein, the term “ambient parameter” and the like is intended to refer to a quantitative or qualitative measure of the environment surrounding battery supply 206, particularly those measures that might affect the heat dissipation rate from battery supply 206 during operation or the ability of battery supply 206 to discharge generated heat. For example, controller 166 may directly monitor the environment where battery supply 206 or cooking appliance 100 is located, e.g., using a temperature sensor or a pressure sensor. It should be appreciated that the environment where the ambient parameter is obtained may refer to the battery storage compartment, the area surrounding the appliance, the kitchen, the house, etc.

As used herein, “temperature sensor” or the equivalent is intended to refer to any suitable type of temperature measuring system or device positioned at any suitable location for measuring the desired temperature. Thus, for example, a temperature sensor may be a thermistor, a thermocouple, a resistance temperature detector, a semiconductor-based integrated circuit temperature sensor, etc. In addition, the temperature sensor may be positioned at any suitable location and may output a signal, such as a voltage, to a controller that is proportional to and/or indicative of the temperature being measured. It should be appreciated that cooking appliance 100 may include any suitable number, type, and position of temperature and/or other sensors according to alternative embodiments. In addition, or alternatively, information about the ambient temperature may be received from a remote sensor (e.g., home energy management system) or any other suitable source.

As used herein, “pressure sensor” or the equivalent is intended to refer to any suitable type of pressure measuring system or device positioned at any suitable location for measuring the desired pressure. Thus, for example, a pressure sensor may be a piezoelectric pressure sensor including an elastically deformable plate and a piezoresistor mounted on the elastically deformable plate. However, it should be appreciated that according to alternative embodiments, the pressure sensor may be any type of pressure sensor that is for obtaining an ambient pressures, such as a resistive, capacitive, optical, or Micro Electro-Mechanical System (MEMS) pressure sensor. In addition, or alternatively, information about the ambient pressure may be received from a remote sensor (e.g., home energy management system) or any other suitable source (e.g., the Internet).

Notably, as explained herein, the effectiveness with which heat is removed from the battery may depend on the ambient conditions or the measured ambient parameter (e.g., such as the ambient air temperature or the ambient air pressure). In this regard, lower ambient temperatures generally facilitate improved convective heat exchange from the battery supply to the ambient environment. Similarly, higher ambient pressures generally facilitate improved convective heat exchange from the battery supply to the ambient environment. Accordingly, aspects of the present subject matter are generally directed to adjusting the operation of a battery supply to limit the maximum battery power threshold based on ambient conditions, ensuring that the battery operates within a desired temperature range (e.g., within its cooling capacity, which may be influenced by ambient parameters) and does not exceed a battery temperature limit.

Specifically, step 320 may include establishing a maximum battery power threshold of the battery supply based at least in part on the ambient parameter of the environment. In this regard, as explained more in the examples below, the controller may select a maximum battery power threshold as a function of the ambient parameter of the environment. The maximum battery power threshold may be a continuous function or a step function of the ambient parameter of the environment. Indeed, it should be appreciated that any suitable model, algorithm, transfer function, or other relationship between the ambient parameter of the environment and the maximum battery power threshold may be used while remaining within the scope of the present subject matter. In addition, step 320 may include selecting a maximum battery power threshold based on multiple ambient parameters, e.g., ambient temperature and ambient pressure.

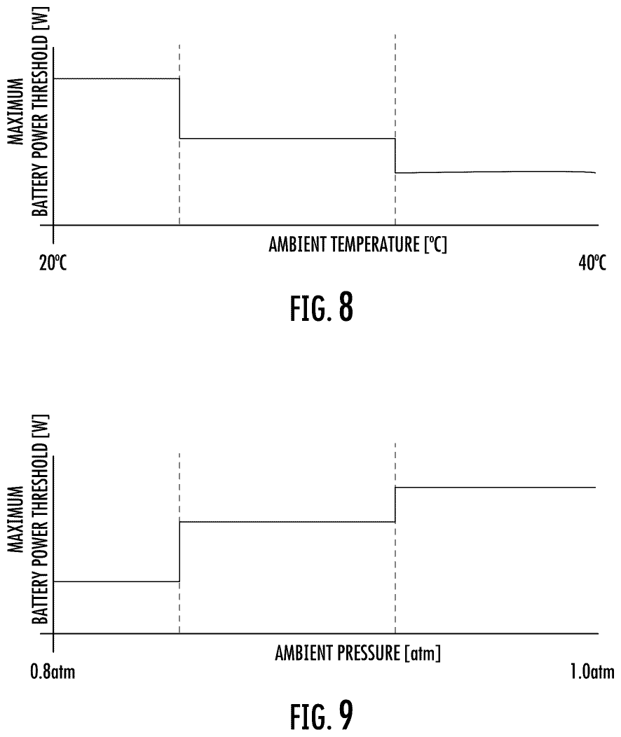

Referring briefly for example to FIGS. 8 and 9, the relationships between the ambient temperatures (FIG. 8) and pressures (FIG. 9) along with a maximum battery power threshold are provided according to an example embodiment. When the ambient temperature increases or ambient pressure decreases, the ability of the battery supply to discharge heat falls. Accordingly, as illustrated, maximum battery power threshold is reduced for higher ambient temperatures and lower ambient pressures. The relationship between the ambient parameters and the maximum battery power threshold may be modeled and stored in the appliance controller, which may then select an appropriate maximum battery power threshold to ensure that a maximum operating temperature of the battery supply is not exceeded.

As shown, the maximum battery power threshold may be adjusted as a step function of the ambient parameters. Specifically, as the ambient temperature increases, the maximum battery power threshold may be decreased (an inversely proportional or negative correlation relationship). Alternatively or additionally, as the ambient pressure decreases, the maximum battery power threshold may be decreased (a proportional or positive correlation relationship). In this regard, as used herein, a positive correlation refers to a situation where one variable tends to increase or decrease as a second variable tends to increase or decrease, respectively. By contrast, a negative correlation refers to a situation where one variable tends to increase or decrease as a second variable tends to decrease or increase, respectively. Positive and negative correlation relationships may be linear, non-linear, parabolic, or any other suitable functional relationship between two or more variables. However, it should be appreciated that that maximum battery power threshold may be adjusted based on a single threshold, a plurality of ambient parameter ranges, or as a continuous function of the ambient parameters.

Step 330 may include operating the power switching system to energize one or more electric heaters to limit electrical power provided from the battery supply to the maximum battery power threshold. In this regard, the power supplied by the battery supply may be limited, regardless of the call-for-heat requested by the cooking appliance, thereby ensuring operation of the battery supply below its rated temperature. According to an example embodiment, method 300 may further include steps for informing the user that the battery usage may be limited, requesting input regarding how the cooking mode should be modified, etc.

For example, method 300 may include receiving a user input to perform a selected cooking mode, calculating a target battery power needed to perform the selected cooking mode, determining that the target battery power is greater than the maximum battery power threshold, and notifying a user that the target battery power is greater than the maximum battery power threshold. Method 300 may further include prompting a user to select from a plurality of power reduction options that reduce the target battery power to a reduced battery power that is less than or equal to the maximum battery power threshold and operating the power switching system to energize the one or more electric heaters in accordance with the plurality of power reduction options at the reduced battery power. Alternatively, method 300 may further include automatically selecting a power reduction options that reduces the target battery power to a reduced battery power that is less than or equal to the maximum battery power threshold and operating the power switching system to energize the one or more electric heaters in accordance with the selected power reduction option at the reduced battery power.

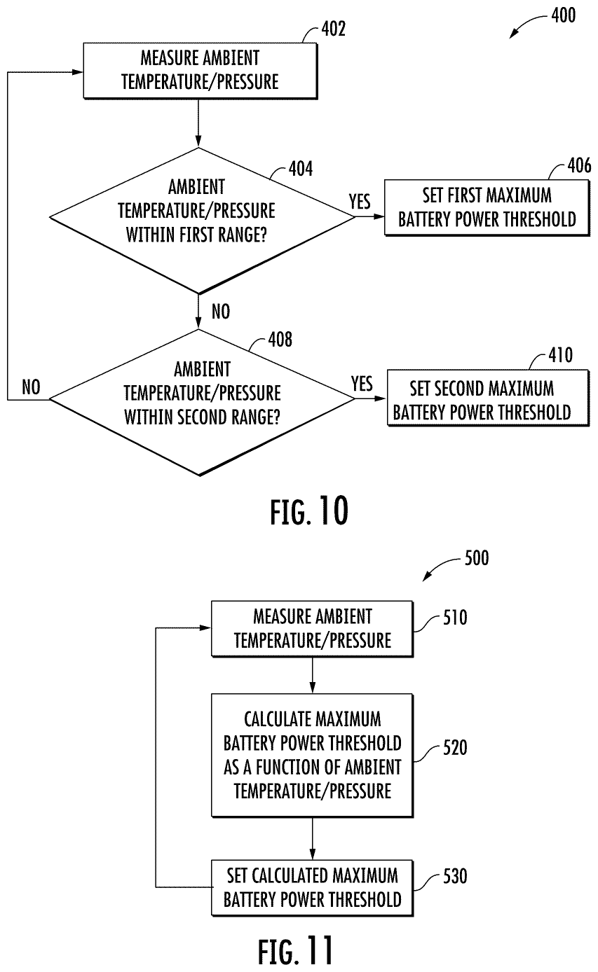

Referring now to FIG. 10, an exemplary flow diagram of a battery-assisted cooking process 400 that may be implemented by cooking appliance 100 will be described according to an exemplary embodiment of the present subject matter. According to example embodiments, method 400 may be similar to or interchangeable with method 300 and may be implemented by controller 166 of cooking appliance 100. As shown, step 402 may include measuring an ambient parameter (e.g., ambient temperature or ambient pressure) around or near the battery supply and communicating the value of the ambient parameter to an appliance controller or a battery controller.

Step 404 may include determining whether the ambient parameter is within a first predetermined range. For example, if the ambient parameter is temperature, step 404 may include determining whether the ambient temperature is between 20 °C and 25 °C, between 25 °C and 30 °C, etc. For example, if the ambient parameter is pressure, step 404 may include determining whether the ambient pressure is between 0.8 atm and 0.85 atm, between 0.85 atm and 0.9 atm, etc. If the ambient parameter within that first range, step 406 may include selecting a maximum battery power threshold associated with that predetermined range. In this regard, the maximum battery power threshold may be selected such that the battery supply remains under a maximum operating temperature limit.

If the ambient parameter does not fall within the first range, step 408 may include determining whether the ambient parameter is within a second predetermined range. For example, if the ambient parameter is temperature, step 408 may include determining whether the ambient temperature is between 25 °C and 30 °C, between 30 °C and 35 °C, etc. For example, if the ambient parameter is pressure, step 408 may include determining whether the ambient pressure is between 0.9 atm and 0.95 atm, between 0.95 atm and 1.0 atm, etc. If the ambient parameter falls within that second range, step 410 may include selecting a maximum battery power threshold associated with that predetermined range. In this regard, the maximum battery power threshold may be selected such that the battery supply remains under a maximum operating temperature limit. Additional ambient parameter ranges and maximum batter power thresholds may be used while remaining within the scope of the present subject matter.

Referring now to FIG. 11, an exemplary flow diagram of a battery-assisted cooking process 500 that may be implemented by cooking appliance 100 will be described according to an exemplary embodiment of the present subject matter. According to example embodiments, method 500 may be similar to or interchangeable with methods 300, 400 and may be implemented by controller 166 of oven appliance 100. As shown, at step 502, measuring an ambient parameter (e.g., ambient temperature or ambient pressure) around or near the battery supply and communicating the value of the ambient parameter to using an appliance controller or a battery controller.

Step 504 may include calculating the maximum battery power threshold as a function of the ambient parameter. In this regard, the appliance controller may store a relationship between the ambient parameter(s) and a maximum battery power threshold, e.g., using a model, transfer function, equation, algorithm, look-up table, etc. Step 530 includes setting the calculated maximum battery power threshold and operating the power switching system to limit operation of the battery supply from exceeding that threshold.

FIGS. 7, 10, and 11 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of methods 300, 400, and 500 are explained using cooking appliance 100 as an example, it should be appreciated that these methods may be applied to the operation of any suitable cooking appliance.

As explained herein, aspects of the present subject matter are generally directed to cooking power management of a battery-assisted cooking appliance, or more specifically, to a method of limiting battery power based on ambient conditions (e.g., such as an ambient temperature or pressure). This method may include limiting the power of a battery in a cooking appliance to maintain the battery below its rated maximum temperature, e.g., by reducing maximum battery power output only when ambient conditions would cause the battery to quickly exceed its rated maximum temperature, while enabling high power output in other conditions. The presently disclosed methods may apply to an oven, a cooktop, and/or a range powered by both main supply with a first voltage and a home battery system with a second voltage.

As noted above, batteries with sufficient energy to power a cooking appliance (e.g., such as lithium-ion batteries) generate heat throughout their use. The effectiveness with which heat is removed from the battery may vary depending on ambient conditions (e.g., air temperature, air pressure, etc.). This heat must be removed to maintain the battery below its rated temperature limit. Limiting the battery's maximum power output reduces its heat generation.

Accordingly, aspects of the present subject matter are directed to methods to adjust the battery's maximum power draw based on ambient conditions, maintaining the battery within rated limits and preserving battery life. The methods described below may be used individually, or they may be combined in one or more permutations (e.g., battery max power threshold may be adjusted based on both ambient temperature and/or ambient pressure). These methods limit the power of a battery in a cooking appliance to maintain the battery below its rated maximum temperature only in conditions that require it, while enabling high power output in other conditions.

Notably, a battery may include a temperature sensor, but the temperature measured by the sensor may not correlate perfectly to the maximum temperature of the battery or the temperature of the battery's critical components. This can create on offset, lag, or lead between measured temperature and the temperature of interest.

Accordingly, aspects of the present subject matter are generally directed to methods of adjusting the maximum battery power threshold based on ambient conditions, thereby compensating for variations in battery cooling. In this manner, the maximum battery power threshold may be decreased when needed to maintain the battery within its operating temperature limit and may be raised to improve heating performance when more self-heating can be tolerated.

According to an example embodiment, a cooking appliance may include any suitable device, probe, or other means of measuring and/or receiving information about ambient temperature. In addition, the cooking appliance may include a means of communicating the ambient temperature to a controller that can adjust the maximum battery power threshold. For example, ambient temperature may be measured using a thermistor, thermocouple, resistance temperature detector, or similar device. In addition, or alternatively, information about the ambient temperature may be received from a remote sensor (e.g., home energy management system) or any other suitable source.

The effectiveness with which a thermal-management system cools the battery may vary depending on ambient conditions. For example, higher ambient temperatures reduce the cooling potential of the thermal-management system. Reducing the maximum battery power threshold reduces the maximum potential heat generated by the battery, reducing cooling requirements.

According to an example embodiment, ambient temperature may be used to determine a suitable maximum battery power threshold. For example, a first maximum battery power threshold (e.g., 6,900 W) may be used at a first ambient temperature, and a second maximum battery power threshold (e.g., 6,500 W) may be used at a second ambient temperature. If the first ambient temperature is greater than the second ambient temperature, the first maximum battery power threshold may be less than the second maximum battery power threshold (and vice versa). The change in maximum battery power threshold may be executed based on an ambient temperature threshold, a temperature range, or as a continuous or step function of ambient temperature. In addition, this method may be extended to more than two ambient temperatures, heat generation rates, and maximum battery power thresholds.

For example, using an ambient temperature range to adjust the maximum battery power threshold may include determining that the ambient temperature is within a predetermined range and setting the maximum battery power threshold to an associated limit. For example, if the ambient temperature is less than 25 °C, the maximum battery power threshold may be about 6,900 W. By contrast, if the ambient temperature is greater than or equal to 25 °C, the maximum battery power threshold may be lower, e.g., about 6,500 W.

According to another example embodiment, a cooking appliance may include any suitable device, probe, or other means of measuring and/or receiving information about ambient pressure. In addition, the cooking appliance may include a means of communicating the ambient pressure to a controller that can adjust the maximum battery power threshold. For example, ambient pressure may be measured using a capacitive or piezoelectric pressure transducer. In addition, or alternatively, information about the ambient pressure may be received from a remote sensor (e.g., home energy management system) or any other suitable source (e.g., the Internet).

The effectiveness with which a thermal-management system cools the battery may vary depends on ambient conditions. For example, lower ambient pressures reduce the cooling potential of an air-based thermal-management system. Reducing the maximum battery power threshold reduces the maximum potential heat generated by the battery, reducing cooling requirements.

According to another example embodiment, ambient pressure may be used to determine a suitable maximum battery power threshold. For example, a first maximum battery power threshold (e.g., 6,900 W) may be used at a first ambient pressure, and a second maximum battery power threshold (e.g., 6,500 W) may be used at a second ambient pressure. If the first ambient pressure is lower than the second ambient pressure, the first maximum battery power threshold may be less than the second maximum battery power threshold (and vice versa). The change in maximum battery power threshold may be executed based on an ambient pressure threshold, a pressure range, or as a continuous or step function of ambient pressure. In addition, this method may be extended to more than two ambient pressures, heat generation rates, and maximum battery power thresholds.

For example, using an ambient pressure range to adjust the maximum battery power threshold may include determining that the ambient pressure is within a predetermined range and setting the maximum battery power threshold to an associated limit. For example, if the ambient pressure is greater than 0.9 atm, the maximum battery power threshold may be about 6,900 W. By contrast, if the ambient pressure is less than or equal to 0.9 atm, the maximum battery power threshold may be lower, e.g., about 6,500 W.

Other variations of the presently disclosed methods are possible and within the scope of the present subject matter. For example, if the reduction in maximum battery power threshold reduces it to less than a battery power minimum threshold, the selected mode may be prevented or canceled. In addition, the battery power minimum threshold may differ between cooking modes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
one or more electric heaters;
a main power connection to a main supply of electrical power;
an auxiliary power connection to a battery supply of electrical power;
a power switching system configured to selectively couple at least one of the main power connection or the auxiliary power connection to the one or more electric heaters; and
a controller in operative communication with the power switching system, the controller being configured to:
obtain an ambient parameter of an environment where the battery supply is located;
establish a maximum battery power threshold based at least in part on the ambient parameter of the environment; and
operate the power switching system to energize the one or more electric heaters to limit the electrical power provided from the battery supply to the maximum battery power threshold.

2. The cooking appliance of claim 1, wherein the ambient parameter is an ambient temperature and the maximum battery power threshold is negatively correlated to the ambient temperature.

3. The cooking appliance of claim 2, wherein establishing the maximum battery power threshold comprises determining that the ambient temperature falls within a predetermined temperature range and selecting the maximum battery power threshold associated with the predetermined temperature range.

4. The cooking appliance of claim 2, further comprising:
a temperature sensor in thermal communication with the battery supply, wherein the ambient temperature is obtained using the temperature sensor.

5. The cooking appliance of claim 2, wherein the controller is in operative communication with a remote temperature source, wherein the ambient temperature is obtained from the remote temperature source.

6. The cooking appliance of claim 1, wherein the ambient parameter is an ambient pressure and the maximum battery power threshold is positively correlated to the ambient pressure.

7. The cooking appliance of claim 6, wherein establishing the maximum battery power threshold comprises determining that the ambient pressure falls within a predetermined pressure range and selecting the maximum battery power threshold associated with the predetermined pressure range.

8. The cooking appliance of claim 6, further comprising:
a pressure sensor positioned proximate the battery supply, wherein the ambient pressure is obtained using the pressure sensor.

9. The cooking appliance of claim 6, wherein the controller is in operative communication with a remote pressure sensor, wherein the ambient pressure is obtained from the remote pressure sensor.

10. The cooking appliance of claim 1, wherein the controller is further configured to:
receive a user input to perform a selected cooking mode;
calculate a target battery power needed to perform the selected cooking mode;
determine that the target battery power is greater than the maximum battery power threshold; and
notify a user that the target battery power is greater than the maximum battery power threshold.

11. The cooking appliance of claim 10, wherein the controller is further configured to:
prompt a user to select from a plurality of power reduction options that reduce the target battery power to a reduced battery power that is less than or equal to the maximum battery power threshold; and
operate the power switching system to energize the one or more electric heaters in accordance with the plurality of power reduction options at the reduced battery power.

12. The cooking appliance of claim 1, wherein the controller is further configured to:
receive a user input to perform a selected cooking mode;
calculate a target battery power needed to perform the selected cooking mode;
determine that the target battery power is greater than the maximum battery power threshold and select from a plurality of power reduction options that reduce the target battery power to a reduced battery power that is less than or equal to the maximum battery power threshold; and
operate the power switching system to energize the one or more electric heaters in accordance with the plurality of power reduction options at the reduced battery power.

13. A method of operating a cooking appliance, the cooking appliance comprising one or more electric heaters, a main power connection to a main supply of electrical power, an auxiliary power connection to a battery supply of electrical power, and a power switching system configured to selectively couple at least one of the main power connection or the auxiliary power connection to the one or more electric heaters, the method comprising:
obtaining an ambient parameter of an environment where the battery supply is located;
establishing a maximum battery power threshold based at least in part on the ambient parameter of the environment; and
operating the power switching system to energize the one or more electric heaters to limit the electrical power provided from the battery supply to the maximum battery power threshold.

14. The method of claim 13, wherein the ambient parameter is an ambient temperature and the maximum battery power threshold is negatively correlated to the ambient temperature.

15. The method of claim 14, wherein establishing the maximum battery power threshold comprises determining that the ambient temperature falls within a predetermined temperature range and selecting the maximum battery power threshold associated with the predetermined temperature range.

16. The method of claim 15, wherein the cooking appliance further comprises:
a temperature sensor in thermal communication with the battery supply, wherein the ambient temperature is obtained using the temperature sensor.

17. The method of claim 15, wherein a controller is in operative communication with a remote temperature source, wherein the ambient temperature is obtained from the remote temperature source.

18. The method of claim 13, wherein the ambient parameter is an ambient pressure and the maximum battery power threshold is positively correlated to the ambient pressure.

19. The method of claim 18, wherein establishing the maximum battery power threshold comprises determining that the ambient pressure falls within a predetermined pressure range and selecting the maximum battery power threshold associated with the predetermined pressure range.

20. The method of claim 18, wherein a controller is in operative communication with a remote pressure sensor, wherein the ambient pressure is obtained from the remote pressure sensor.
